(19) United States
(12) Patent Application Publication
(10) Pub. No.: US 2010/0081014 A1
(43) Pub. Date: Apr. 1, 2010

(54) Microbial Fuel Cell Power Systems

(75) Inventors: Robert C. Tyce, Coventry, RI (US); Jeffrey W. Book, Slidell, LA (US); Leonard M. Tender, Bethesda, MD (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The Government of the United States of America, as represented by the Secretary of the Navy, Washington, DC (US)

(21) Appl. No.: 12/554,062

(22) Filed: Sep. 4, 2009

Related U.S. Application Data
(60) Provisional application No. 61/096,347, filed on Sep. 12, 2008.

(51) Int. Cl. H01M 8/16

(52) U.S. Cl. 429/2

(57) ABSTRACT

The present invention provides a microbial fuel cell power system based on a microbe-based fuel cell such as a benthic microbial fuel cell (BMFCs). In accordance with the present invention, one or more BMFCs can be connected to one or more batteries such as a nickel metal hybrid (NiMH) or sealed lead acid (SLA) battery and can be used to charge the batteries for long-term persistent underwater use. At any time, some of the connected batteries are being charged by the BMFC, while the others are being used to power a connected device. By using electrically isolated fuel cell converters, the batteries can be charged while in circuit. With non-isolated converters, pairs of batteries can be switched between offline charging and online discharging. The battery system can be controlled by a control system that comprises a microcontroller that periodically measures system voltages and currents, swaps the batteries being charged, and records the system results for post-mission analysis. The batteries can be connected to an underwater monitoring system such as the Acoustic Doppler Current Profiler (ADCP) or Shallow-Water Environmental Profiler in Trawl-Safe Real-Time Configuration (SEPTR) systems used by the U.S. Navy and can provide long-term persistent power supplies to such systems.

### CROSS-REFERENCE

This application claims the benefit of priority based on U.S. Provisional Patent Application No. 61/096,347 filed on Sep. 12, 2008, the entirety of which is hereby incorporated by reference into the present application.

### TECHNICAL FIELD

The present invention relates to power systems based on microbial fuel cells which can generate electrical power from voltage gradients at sediment-water interfaces.

### BACKGROUND

The Navy and other marine-based activities such as fisheries, marine researchers, and operators of merchant vessels utilize a wide variety of marine-deployed devices. These devices include acoustic Doppler velocity profilers, acoustic sensors, seismometers, conductivity and temperature probes, surveillance instrumentation and various chemical sensors and transponders. Such devices currently provide valuable information about marine environments and/or enable Navy activities within marine environments. Ongoing developments in low-power microelectronics, sensors, and data telemetry continually expand their scope and impact.

Typically, these in-water marine/oceanographic devices are powered by batteries. The key limitation of battery-based power supplies is battery depletion (i.e., exhaustion of energy content) which limits the period of time over which a sensor or instrument can operate. Although many marine/oceanographic devices deployed in water can operate for short periods of time that are easily sustained by batteries, many others (present or envisioned) are designed to operate unattended for longer periods of time. However, such long-term operation is only possible by having the device be retrieved and redeployed with fresh batteries or having additional devices deployed sequentially. Both scenarios are cost and resource intensive, compromise covertness, and interrupt continuity of operation.

As a consequence, the long-term uninterrupted (i.e., persistent) operation of such devices, widely recognized as a desired capability, is not possible. It is widely recognized that many of these sensors and instruments would provide greater benefit if they could operate persistently.

Alternatively, sometimes finite deployment durations for an instrument are set by other constraints, e.g. logistical considerations, limited required time for mission support, etc. In these cases it is typical for the sampling rate of the instrument to be directly determined by the expected battery depletion rate. Although higher sampling rates may be desired and be of benefit, lower sampling rates must be used to ensure battery life persists throughout the deployment duration. If additional power were available, a higher sampling rate for the instrument would in many cases produce a higher quality data product.

Solar-based power is a proven source of persistent low power for devices deployed on or just below the water surface. Solar-based power is, however, prone to fouling when utilized in marine environments limiting deployments of solar-powered devices up to 1-year in cold environments and substantially shorter in warm environments unless periodic cleaning of the device can be done. As light is attenuated rapidly with depth in water, devices deployed on the ocean bottom cannot benefit at all from solar power except in the cases of extremely shallow deployments or when attached by cables with surface buoys. The latter situation increases the risk of damage or destruction by fishing or shipping traffic.

Alternatively, marine/oceanographic devices deployed in water can be powered by direct connection to land-based power sources. The key limitation of land-based power supplies for marine/oceanographic devices deployed in water is their reliance on electrical cables which are very expensive to construct and deploy, which limit geographic scope and range of deployment, and which are susceptible to hazards including weather and trawling that can cause periodic shutdowns of their operation.

One solution to this problem that has been developed is the benthic microbial fuel cell (BMFC). See Reimers et al., “Harvesting Energy from the Marine Sediment-Water Interface,” Environmental Science and Technology, Vol. 35 No. 1, pp. 192-195 (2001); Tender et al., “Harnessing Microbially Generated Power on the Seafloor,” Nature Biotechnology 20, pp. 821-825 (2002); Bond et al., “Electrode-Reducing Microorganisms That Harvest Energy from Marine Sediments,” Science, Vol. 295, pp. 483-485 (18 Jan. 2002); and U.S. Pat. No. 6,913,854 to Alberte et al., all of which have an author or inventor in common with the present invention and are incorporated by reference into the present disclosure in their entirety.

The BMFC consists of an electrode embedded in anoxic marine sediment or in contact with anoxic porewater of anoxic marine sediment connected by an external electrical circuit to an electrode positioned in overlying water. In many fresh- and salt-water marine environments substantial organic matter resides in sediment which sustains microbial activity that is limited by flux of oxidants (such as oxygen and sulfate) into sediment from overlying water. Within the topmost millimeters to centimeters of such sediments, microorganisms preferentially deplete oxygen, causing microorganisms deeper in sediment to utilize less potent oxidants (such as sulfate) and generate as byproducts potent reductants (such as sulfide). As a consequence, a natural redox gradient exists across the sediment/water interface in which porewater within such marine sediment millimeters to centimeters beneath the sediment surface is enriched in reductants compared to overlying water. Because of this redox gradient, an electrode imbedded in such marine sediment or in contact with anoxic porewater of such anoxic marine sediment will equilibrate to an electrical potential that is often more than 0.7 volts negative compared to the electrical potential of a comparable electrode positioned in overlying water at open circuit (i.e., when the electrodes are not electrically connected).

Connection of the electrodes by an external circuit of appropriate resistance results in sustainable electron flow (electrical current) from the sediment imbedded electrode (termed “anode” because of its negative voltage) to the electrode in overlying water (termed “cathode” because of its positive voltage). Current is sustained at the anode by continual oxidation of reductants in sediment porewater and at the cathode by continual reduction of oxidants in water. The acquired electrons flow from the anode through the external circuit where they can do work (such as power a marine deployed sensor or instrument) and continue with diminished potential to the cathode. Continual supply of the electrode reactants and continual removal of the electrode products by natural processes ensure long-term (persistent) low-power generation (typically 0.01-1 W depending on size) at low voltage (typically about 0.4 V). However, the BMFC cannot be used directly to effectively power in-water marine/oceanographic devices without an effective control/monitoring interface.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides a marine power system based on a microbial fuel cell such as a benthic microbial fuel cell (BMFC). In accordance with the present invention, one or more BMFCs can be connected to one or more batteries such as a nickel metal hybrid (NiMH) or sealed lead acid (SLA) battery and can be used to charge the batteries for long-term persistent underwater use. At any time some of the connected batteries are being charged by the BMFC, while others are being used to power a connected device. By using electrically isolated fuel cell converters, the batteries can be charged while in circuit. With non-isolated converters, pairs of batteries can be switched between offline charging and online discharging. The battery system can be controlled by a system that includes a microcontroller that periodically measures system voltages and currents, swaps the batteries being charged, and records the system results for post-mission analysis. The batteries can be connected to an underwater monitoring system such as the Acoustic Doppler Current Profiler (ADCP) or Shallow-Water Environmental Profiler in Trawl-Safe Real-Time Configuration (SEPTR) systems used by the U.S. Navy and can provide long-term persistent power supplies to such systems.

### BRIEF DESCRIPTION OF THE DRAWINGS

FIG. 1 is a block diagram depicting aspects of a microbial fuel cell used in a power system in accordance with the present invention.

FIGS. 2A and 2B are block diagrams illustrating exemplary embodiments of a microbial fuel cell power system in accordance with the present invention.

FIG. 3 is a block diagram illustrating elements of an exemplary controller/monitor used in a microbial fuel cell power system in accordance with the present invention.

FIG. 4 is a flow chart illustrating an exemplary wakeup, control, and monitoring sequence for a controller/monitor for a microbial fuel cell power system in accordance with the present invention.

FIG. 5 illustrates aspects of an exemplary embodiment of a microbial fuel cell power system contained within an oceanographic housing for connection to an Acoustic Doppler Current Profiler (ADCP) in accordance with the present invention.

FIG. 6 illustrates aspects of an exemplary embodiment of a microbial fuel cell power system for a Shallow Water Environmental Profiler in Trawl-resistant Real-time configuration (SEPTR) in accordance with the present invention.

FIG. 7 is a block diagram showing a configuration of an exemplary embodiment of a microbial fuel cell power system for a SEPTR sensor in accordance with the present invention.

FIG. 8 illustrates an exemplary embodiment of a SEPTR sensor equipped with a microbial fuel cell power system being readied for deployment in accordance with the present invention.

FIG. 9 is a block diagram illustrating aspects of another embodiment of a microbial fuel cell power system in accordance with the present invention.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

For example, the present invention is often described in the context of two exemplary configurations in which a benthic microbial fuel cell (BMFC) is used to power batteries for an Acoustic Doppler Current Profiler (ADCP) system and a Shallow-Water Environmental Profiler in Trawl-Safe Real-Time Configuration (SEPTR) systems. However, one skilled in the art would appreciate that the battery system of the present invention can be used with any microbe-energy based underwater fuel cell or to power any suitable device and that many other configurations and applications of a BMFC-powered battery system can be made. In addition, although the present invention is described in the context of particular components, such particular components are merely exemplary and other similar or otherwise compatible components may also be used within the scope and spirit of the present disclosure.

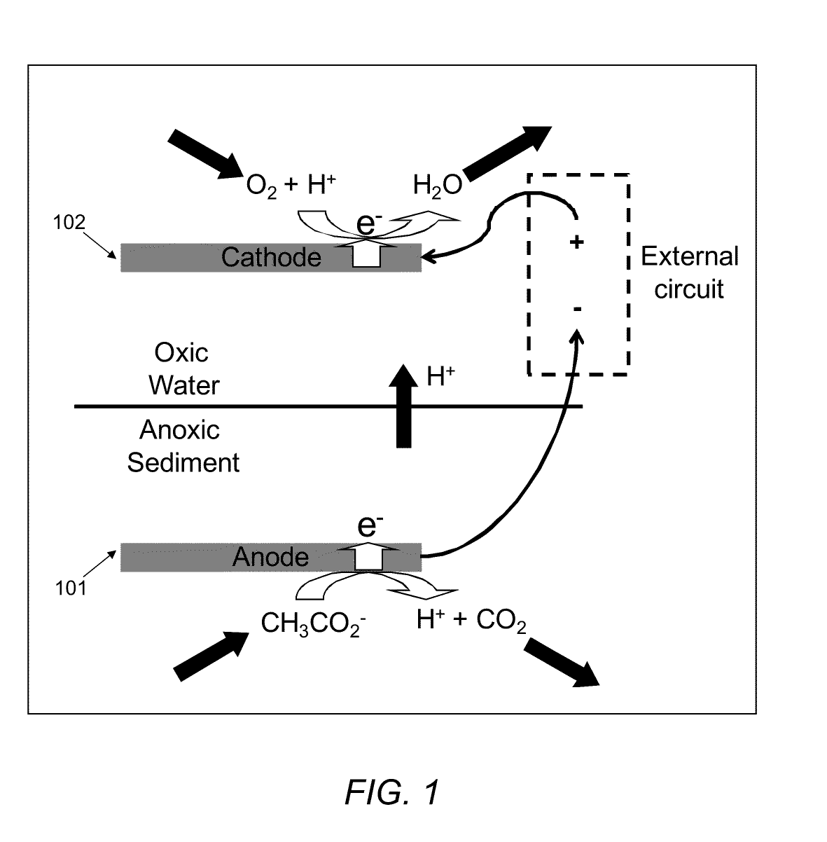

A schematic of an exemplary BMFC microbial fuel cell is shown in FIG. 1. As shown in FIG. 1 and as described briefly above and in detail in U.S. Pat. No. 6,913,854 incorporated herein, power can be generated from the potential difference created at sediment-water interfaces due to the naturally occurring decomposition of microbes in underwater sediment. Such power can be generated by placing an anode 101 in the sediment near the sediment-water boundary and placing a cathode 102 in the water over the anode. The anode has a lower electrical potential than the cathode, and when the anode is connected to the cathode through a load, this potential difference creates a near perpetual generation of current which can be used to power a connected device.

The University of Rhode Island Ocean Engineering Department has been working with the U.S. Naval Research Laboratory to develop BMFCs for low-power consuming seafloor applications of extended duration. This activity required the development of control and monitoring systems to regulate discharge of the BMFCs and to monitor their performance without consuming a significant portion of the low power they generate. As noted above, using the naturally occurring potential gradient difference created from microbial decay in marine sediment, BMFCs generate power on the order of about 0.4V. In order to make use of BMFC generated power for oceanographic devices that tend to use power periodically, the 0.4 V BMFC power output must be boosted in voltage to a useful level and stored for use.

Thus, in accordance with the present invention, the BMFC voltage can be boosted to a useful level, for example by means of DC/DC converters, to a voltage capable of charging a battery such as a 12V sealed lead acid (SLA) or nickel metal hybrid (NiMH) battery. This conversion needs to be done very near the electrodes to minimize line IR losses, which accumulate quickly over short distances for these low voltage/high current generators. Sets of such BMFC-charged 12V batteries can then be combined to provide higher voltages, either by removing batteries from the active circuit for charging, or by charging multiple batteries in series by means of isolated converters. Converters that can be used to boost BMFC voltage include the current mode converters developed for this project by Northwest Metasystems to charge 12V batteries with an efficiency of 60-70%.

As described in more detail below, the present invention provides a microbial fuel cell power system wherein batteries such as 12V SLA and NiMH batteries can be charged from microbial fuel cells such as BMFCs. In accordance with the present invention, one or more BMFCs can be connected to one or more batteries and, using a voltage booster such as a DC/DC converter, can be used to charge the batteries for long-term persistent underwater use. At any time some of the connected batteries are being charged by the BMFC, while others are powering a connected device. By using electrically isolated fuel cell converters, the batteries can be charged while in circuit. With non-isolated converters, pairs of batteries can be switched between offline charging and online discharging. A microbial fuel cell power system in accordance with the present invention can include a control and monitoring system that periodically measures system voltages and currents, swaps the batteries being charged, and records the system results for post-mission analysis. To save power, the controller can be in an inactive state until being awoken, for example by a remote signal or a real time clock connected to the microcontroller. Once awake, the controller can record information regarding the BMFC and the connected batteries such as system and battery voltages and charge/discharge currents and can switch the batteries being charged by the BMFC, for example by means of latching relays. The batteries can be connected to an underwater monitoring system such as the Acoustic Doppler Current Profiler (ADCP) or Shallow-Water Environmental Profiler in Trawl-Safe Real-Time Configuration (SEPTR) systems used by the U.S. Navy and can provide long-term persistent power supplies to such systems.

These and other aspects of the present invention will be described in more detail below.

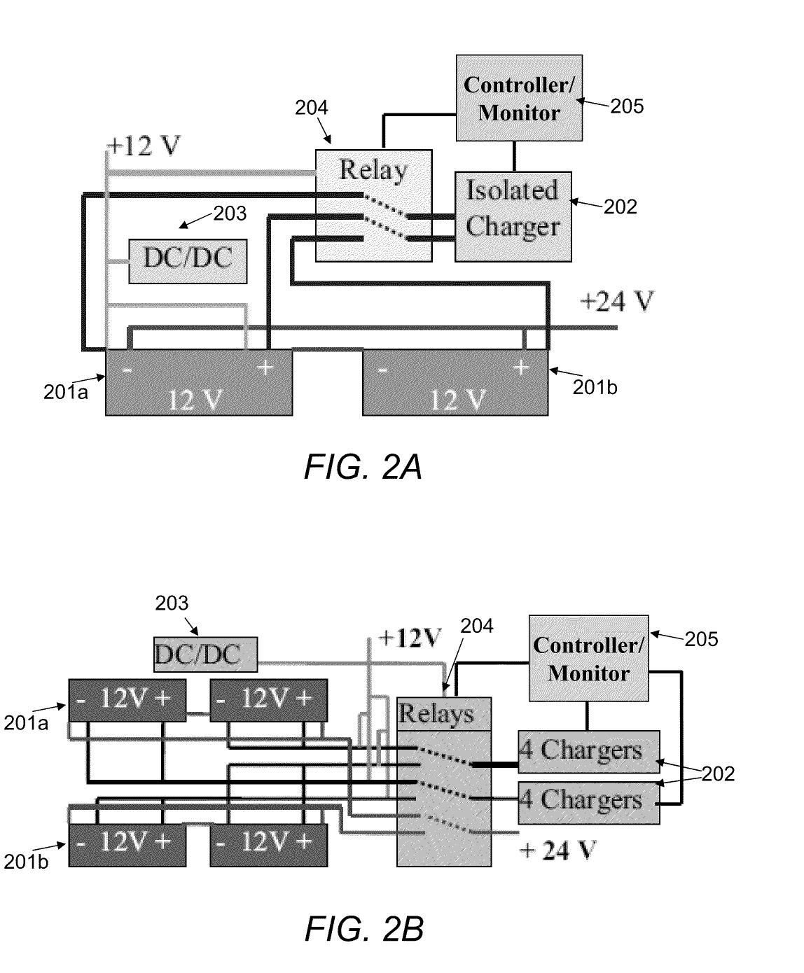

As noted above, in accordance with the present invention, a set of BMFCs can be connected to a corresponding set of batteries to be charged from the microbial generated BMFC voltage. As illustrated in the exemplary embodiments shown in FIGS. 2A and 2B and as described in more detail below, two or more 12V batteries 201a, 201b can be connected in parallel to one or more BMFC battery chargers 202 via a voltage booster such as a DC/DC converter 203 to create a total voltage output of 24V or more. The BMFC and the batteries also can be connected to a latching relay 204 such as a 4PDT latching relay which controls which battery is in an “offline” state, i.e., being charged by the BMFC, and which battery is “online,” i.e., providing power to a connected device such as an ADCP or SEPTER profiler. The batteries themselves are connected in series to the powered device so that at any time some of the batteries are being charged at 12V by the BMFC while others are providing 24V power to the connected device.

In accordance with the present invention, a BMFC-based battery system can also be connected to a controller/monitor 205 to switch the batteries connected to the BMFC from an offline/charging state to an online/active state. The controller is woken up periodically, e.g., by a real time clock or by a remote signal, to monitor the status of the battery system and record performance data. The controller receives date and time information, either from the real time clock or the remote signal, and at predetermined intervals, e.g., once a day, once a week, etc., alternates the batteries being charged and those being discharged.

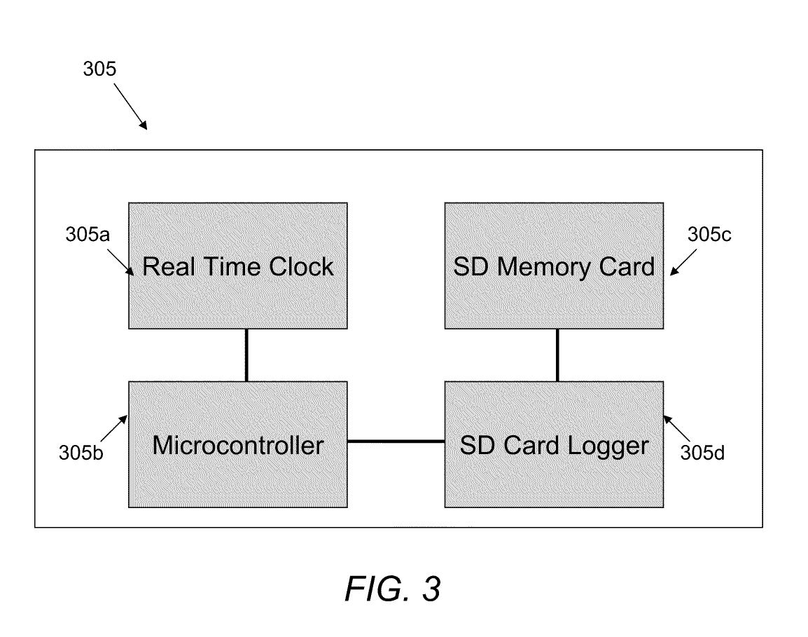

FIG. 3 is a block diagram depicting elements of an exemplary controller/monitor 305 (same as controller/monitor 205 shown in FIGS. 2A and 2B above) that can be used in a battery system in accordance with the present invention. As shown in FIG. 3, and as described in more detail below, controller/monitor 305 can comprise a microcontroller 305a, a Real Time Clock 305b, an SD Card Logger 305c, and a memory such as an SD Card 205d. In other embodiments, Real Time Clock 305b can be replaced by a receiver configured to receive a remote signal such as a wake-up signal, SD Card Logger 305c can be replaced by any suitable data logger, data transfer, or data writing mechanism, and SD Card 205d can be replaced by any suitable non-volatile memory using any suitable medium such as a magnetic disk, magnetic tape, flash memory or other medium

In order to ensure that the controller/monitor does not excessively drain the BMFC power it is important that the controller consume only a very small amount of power when on and preferably no power when it is off. Thus, in one exemplary embodiment, a microcontroller used in accordance with the present invention can comprise one or more object-oriented programmable integrated circuits programmed in Basic such as the OOPIC microcontroller produced by Microchip Technology, Inc. as the core low power computer. The OOPIC is a very small microcontroller which consumes 16-20 mA at 5 volts (80-100 mW) when on and OA when off. It operates and is programmed via 9600 baud RS232 3 wire serial communication and has a 4 channel/10bit A/D converter expanded by multiplexer chips to 12 channels for monitoring voltages and currents via current sensing ICs. Its programs are stored on EEPROM, and immediately start from the beginning each time the OOPIC is powered up. In addition, notes from the previous time awake can be stored in the EEPROM below the program and can be used determine previous actions taken by the controller and provide information for use by the OOPIC in performing one or more of its functions during the current wake cycle. At the end of the program the processor turns off power to keep power consumption to a minimum. As described in more detail below, no system power is used by the controller until woken up.

As noted above, because the BMFC generates such a small voltage, the controller also needs to be kept asleep most of the time to avoid consuming a large fraction of the available power. For example, if allowed to run continuously, a 100 mW OOPIC would consume nearly all of the power generated by a 100 mW BMFC. To prevent such a drain on the available BMFC power, the controller can be turned on, either by a real time clock in some embodiments or by a remote signal in others. Little or no system power is used by the OOPIC until it is woken up. Once awake, the OOPIC can check the date, monitor/control the system status and even operate a low power pump via PWM output for enhancing BMFC electrode performance.

In embodiments using a real time clock, the OOPIC can be awoken by an electronic alarm, for example, from an I2C real time alarm clock chip (DS1337) with its own multi-year lithium battery which can maintain crystal-controlled date and time without using any system power. The Real Time Clock (RTC) can be programmed to wake up the system at a specific date and time or at any of several intervals. Alternatively, a controller at a remote site can be programmed to send a wake-up signal to the controller at the desired intervals. For example, the RTC can be programmed to wake up the OOPIC once a day to switch the batteries being charged and once an hour to record system information such as voltage and current use. The wake-up time for switching the batteries can coincide with one of the hourly wake-up cycles so that the battery switching is performed in addition to the hourly monitoring functions or can be programmed to be a separate wake-up that is staggered from one of the hourly wake-up cycles so that the battery switching is performed independently from the monitoring functions.

In other embodiments, the OOPIC can be woken up remotely by applying a few volts of power to one of the RS232 handshake lines which is connected to a parallel wakeup circuit which switches on both the controller and RS232 power. In this embodiment, the remote signal also can be used to effect reprogramming and system configuration changes if such changes are desired.

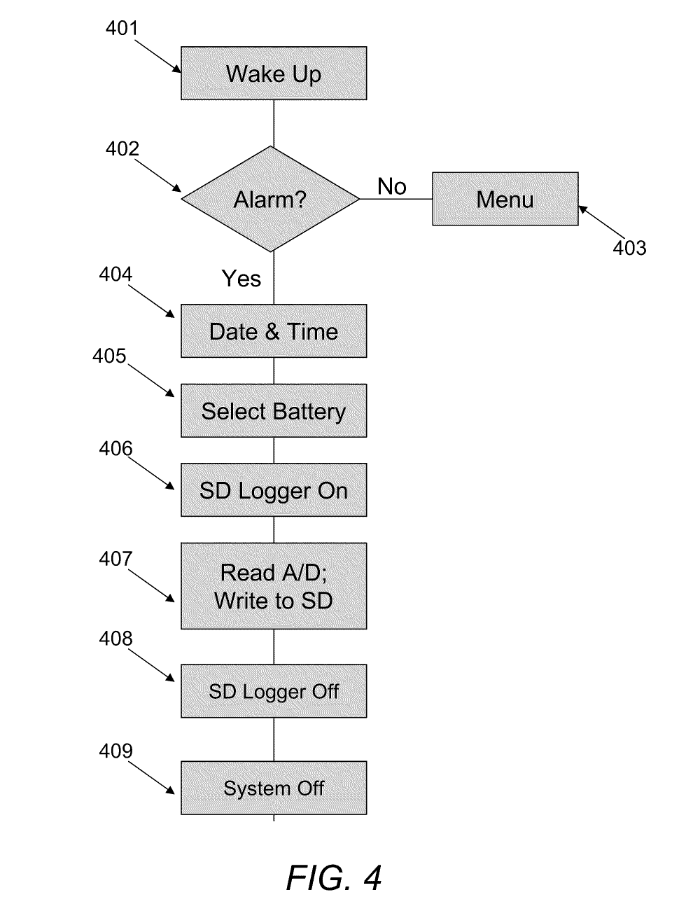

FIG. 4 depicts an exemplary logic flow used by the microcontroller software in accordance with the present invention. At step 401, the OOPIC is woken up, and at step 402, it can determine whether it was awoken by an RTC alarm or remotely. For example, a remote wakeup can be indicated if an RTC alarm flag is not set. If at step 402, the answer is no, i.e., the RTC alarm flag is not set, the OOPIC determines that it is a remote wakeup, and at step 403 the system can display an RS232 menu and stay awake for a short period awaiting input or reprogramming from the surface. On the other hand, if the answer at step 402 is yes, i.e., the RTC alarm flag is set, the system can proceed with its normal monitor and battery charge management tasks described above. These include receiving date and time information from the RTC at step 404 and alternating the batteries being charged by switching the state of latching relays at step 405 if appropriate (e.g., the date and time indicate that a swap of the batteries is due). At step 406, the SD logger is turned on and at step 407, the SD logger can read from A/D and write to the SD card to record system and status information such as date and time, system and battery voltages, and charge/discharge currents. When finished with all tasks, at step 408 the system shuts down logger power before turning off its own power at step 409. Once powered down, the system can then only be turned back on by the clock or by the surface RS232 connection.

As noted above, the microcontroller can be operatively connected to a memory device such as a micro SD card connected to an independent micro SD card logger (for example, the DOSONCHIP card logger made by Wearable, Inc. or the μALFAT chipset made by GHI Electronics, LLC). Using the logger, the memory device can be used to store long term measurements over many months, for example, by means of serial FAT16 ASCII files. The logger uses very little power, for example, only 3-5 mA at 3.3 volts when not writing, and a momentary 40-70 mA to write.

The OOPIC communicates with the logger in low power TTL serial ASCII.

Communication with the surface (as well as programming) is done via RS232 serial using an RS232 chip (MAX242) that manufactures +/−10V RS232 signals from +5V when enabled with only a few milliamps of additional power consumption. This chip is connected to TTL serial lines on the OOPIC controller and SD card logger from which it produces RS232 signals capable of driving over 100 m of cable at 9600 baud. The OOPIC can have RS232 signals available directly, but these signals are too weak to drive long cables. Power to the SD card logger and the RS232 chip is controlled by the OOPIC. The OOPIC controls their power to minimize consumption, and when the OOPIC is asleep the controller subsystems don't consume any power. In an exemplary embodiment, the controller can be woken up, report data, accept commands, or be reprogrammed, all through an 8-wire 3×RS232 serial cable (1-OOPIC, 2-SD logger, 3-ADCP or AUX device). The main power latching relay can be triggered with a few volts on one of the RS2332 handshake lines. The OOPIC does not normally use the handshake lines, requiring only transmit, receive and ground signals for programming (and communication on the same lines).

After the completion of a mission using a power system in accordance with the present invention, for example, after completion of a SEPTR mission, the SEPTR device can be recovered and the SD card removed so that the power system performance data can be retrieved. In other embodiments, the performance data can be accessed by means of a cable such as an 8-pin serial program connector and cable connected to the controller/monitor. In still other embodiments, the controller can include a transmitter such that the recorded performance information can be periodically transmitted to a receiver at a remote site, for example, as part of a wake-up cycle triggered by a remote signal described above.

The microcontroller can be programmed to awake periodically for very short periods of time to monitor a multi-month system deployment and record the results on a memory medium such as an SD card. For example, the microcontroller can be programmed to awake once an hour for 20 seconds (0.55% on time), keeping the average controller power consumption of the control system very low, e.g., to less than 2 mW averaged over an hour or more for the SEPTR controller with high power Panasonic 4PDT latching relays (133 mA to switch). The ADCP controller uses even smaller Omron DPDT relays which consume almost 1/10 the relay power, reducing average power consumption to less than 1 mW.

As described above, an underwater power system in accordance with the present invention can monitor and control the charging of batteries such as 12V NIMH or SLA batteries from the BMFC converter/charger so that such batteries can be used to persistently power their connected devices. Charging is a continuous process which is monitored periodically, e.g., once per hour, with time, voltage and current measurement values being saved as ASCII files on a memory such as an SD card and the batteries charged being switched periodically, i.e., once per day, by means of latching relays.

FIG. 2A is a block diagram illustrating an exemplary 24V power system for powering an

Acoustic Doppler Current Profiler (ADCP) instrument in accordance with the present invention. Such an exemplary power system can include two 12V batteries 201a and 201b wired in series that can be charged by means of a single isolated BMFC converter/charger 202. In accordance with the present invention, controller 205 can wake up each hour to monitor voltage and currents, and can periodically switch which one of batteries 201a and 201b is being charged. The ADCP can be programmed to consume anywhere from 0.1 to 1.2 watts of power within its normal operational specifications for reasonable current measurement accuracies. Thus, the combined system described here can either extend the deployment duration of an ADCP maintaining a normal sampling frequency or allow for a higher sampling frequency (i.e. higher power consumption) over a pre-determined deployment duration, with benefit to the measurement quantity or quality.

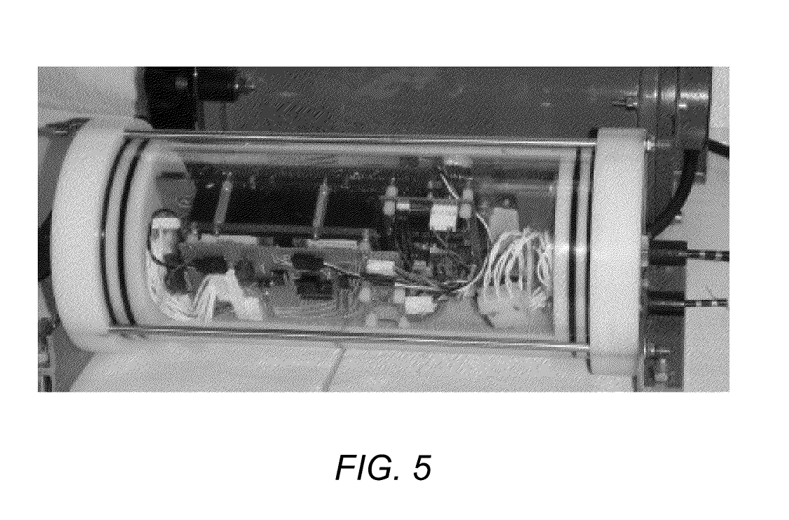

FIG. 5 shows an exemplary embodiment of an actual packaged controller system for an ADCP in accordance with the present invention. As shown in FIG. 5, the controller is situated within a cast-acrylic pressure housing that contains OOPIC controller and latching relay boards, dual 12V battery packs wired in series for 24V, and a single electrically isolated BMFC charger. BMFC electrodes and ADCP connections are cabled through bulkhead connectors and a backup 24V battery pack is located inside the ADCP housing shown in the background. In this embodiment, the batteries can be charged by the BMFC while they also are in circuit with the connected device.

For a more power-hungry SEPTR environmental profiler system, a 24V power system in accordance with the present invention can be used. In an exemplary embodiment of such a SEPTR system shown in FIG. 2B, two pairs 201a, 201b of high capacity 12V Sealed Lead Acid (SLA) batteries used in series as 24V can be switched in pairs between independent charging at 12V by the 4-ganged BMFCs with isolation diodes and operation in 24V series. The BMFC canister can be used together with other (e.g., up to three) standard non-BMFC SEPTR battery canisters which can contribute power in parallel via isolation diodes. Thus in one exemplary embodiment, at any moment in time two 12V SLA batteries can be charged offline by the BMFC power system while the alternate two 12V SLA batteries can provide 24V power along with the other standard 24V battery canisters inside the SEPTR. In the exemplary configuration shown in FIG. 2B, the batteries on charge each have 4 separate BMFC systems and converters 201 contributing charge in parallel via low voltage Schottky diodes and underwater pluggable connectors. In all, 8 separate converters charge the two offline batteries, with the batteries being swapped in pairs between online and offline by means of two 4PDT latching relays periodically, for example, once a day, once a week, etc..

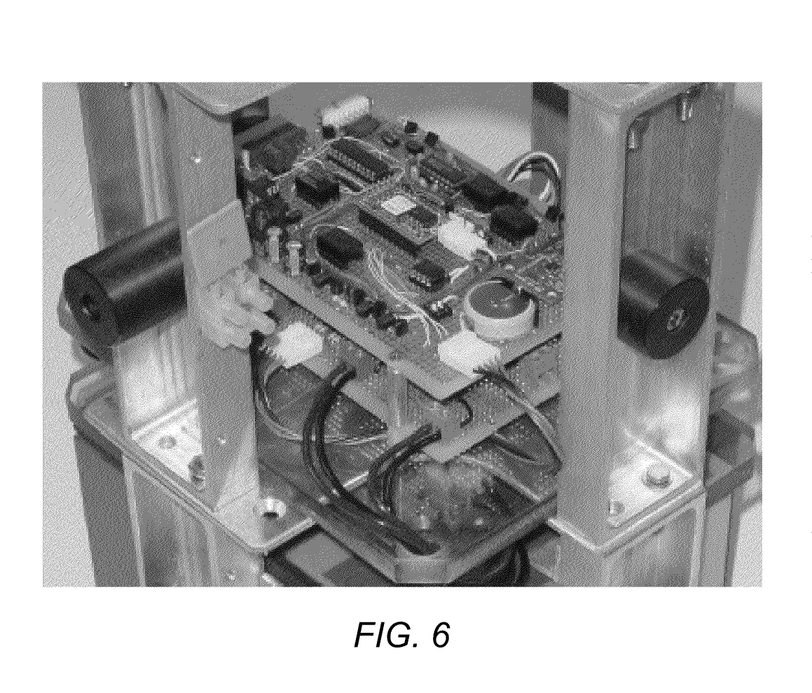

FIG. 6 shows an interior view of an exemplary SEPTR BMFC controller canister. The top electronics board contains the OOPIC controller, Real Time Clock with battery, SD Card logger, RS232 electronics and A/D converter multiplexer. Beneath this board is the main latching relay board with Schottky diodes and current monitor electronics for inputs from the 8 BMFC chargers. In this case the chargers are potted units attached directly to the BMFC electrode assemblies and cabled to the controller canister. Cable length issues are greatly reduced once the chargers convert the 0.4V BMFC voltage to 12V for charging, so an array of BMFC units with potted chargers, each one about 1 ft×1 ft×3.5 ft in size, can be installed around a SEPTR instrument without significant line losses. Underwater pluggable connectors on the charger units and isolation diodes on the controller allow the chargers to be connected underwater after the BMFC electrode sets have been buried in the sediment and suspended in the water column.

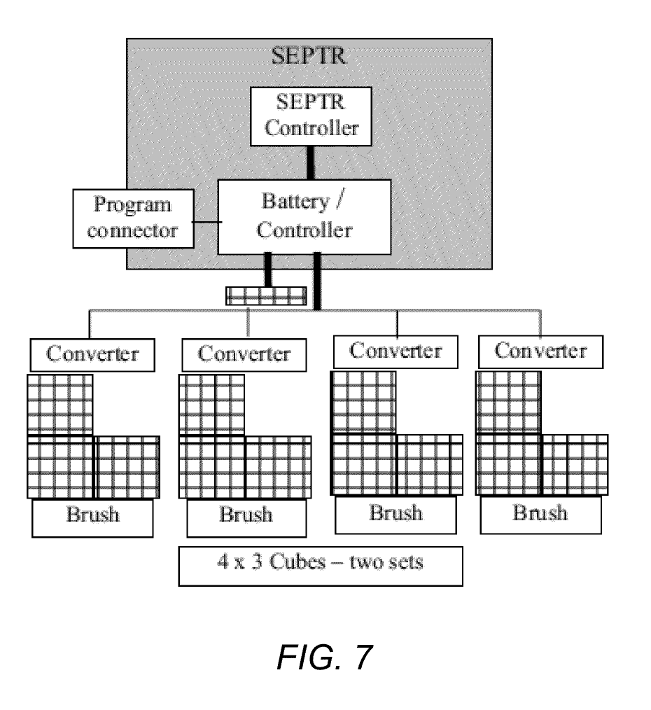

FIG. 7 is a block diagram of another exemplary embodiment for a SEPTR BMFC-based electrode and charging system for in accordance with the present invention. Here sediment graphic plates have been assembled into electrode cubes to form the approximately 3.5 ft long anodes. These three cubes are combined along with bottle brush shaped water column graphite electrodes for input to each converter.

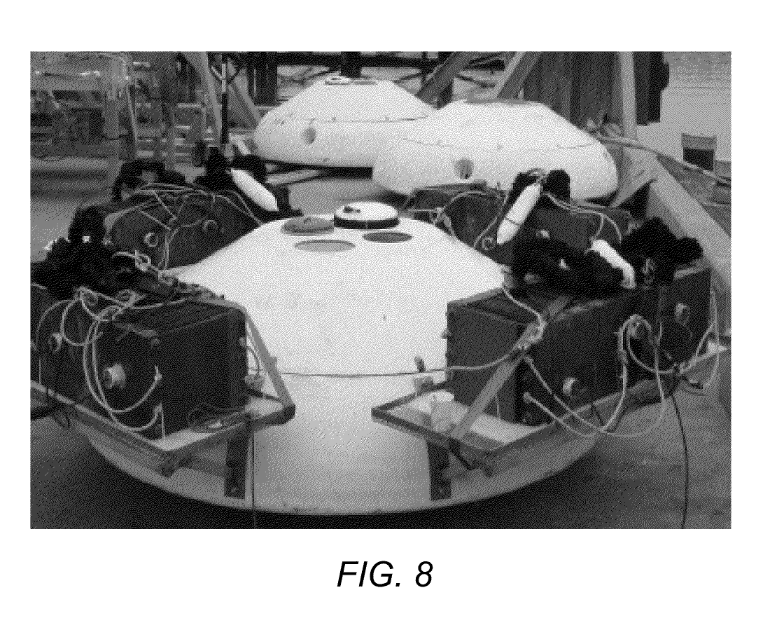

FIG. 8 depicts an exemplary SEPTR system utilizing a BMFC-based battery system in accordance with the present invention, the system being ready for deployment. In the foreground of FIG. 8, a BMFC-equipped SEPTR instrument rigged with trays to carry the BMFC electrodes and chargers to the seafloor for deployment. In the background are two normal SEPTR units. In the configuration shown, the SEPTR contains an ADCP instrument (not shown in the photo) plus a profiling buoy (white cylinder at the top of the device) winched to and from the surface where it communicates ashore via satellite. In preparation for this deployment two BMFC electrodes are interleaved with each other and placed on a single tray to allow four trays to carry eight electrodes. Divers would be needed to separate the BMFC electrodes and bury them around the deployed SEPTR.

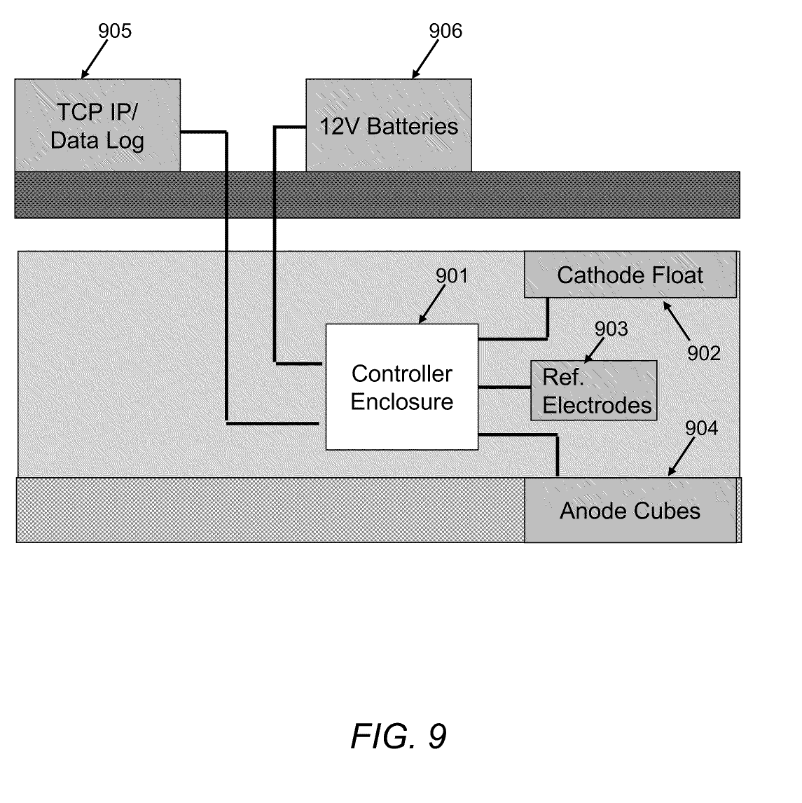

The ADCP and SEPTR systems described above are designed to stand alone and log data to a microSD card within the monitor/controller. However, in other embodiments, the BMFC control system can be cabled ashore so that operations can be monitored in real time. FIG. 9 presents a block diagram of such an embodiment. As shown in FIG. 9, controller enclosure 901 was submerged along with cathode float 902 and reference electrodes 903. The graphite anode electrode cubes 904 were buried in the mud below the dock and connected to controller 901, with an Internet-connected Netburner TCP/IP data logger 905 and a 12V battery canister 906 located dockside. In this embodiment, the system can be programmed to provide serial connectivity to the BMFC controller over the internet via Telnet, which can allow a user to connect to the controller from a remote site and either log data or change system parameters via the controller menu when the controller is awake.

With microbial fuel cell systems expected to provide 10-1000 mW of power, it can be a challenge for the control and monitoring system to consume a small fraction of the available power and to be able to run for years. The present invention addresses this problem by having the controller disconnect itself from all power at the end of each wakeup cycle, then using a separate real time clock alarm with independent multi-year lithium battery to reconnect the controller at programmed intervals.

Thus, by combining a low power BMFC microcontroller, real time clock, SD card logger and latching relay components, the present invention can provide a seafloor microbial fuel cell battery system that consumes very little power and can run for years. In addition, connecting this system to a communications system such as an internet-based microcontroller using FTP and TCP/IP Telnet functionality when the system can be cabled or wirelessly connected ashore can allow real-time monitoring and control. Because no power is consumed by the controller when it is asleep, realistic long-term deployment simulation of these systems can be achieved by automatically advancing the time being kept by the real time clock wakeup system to just before the next wakeup time, then putting the system to sleep as usual. By reducing the on time duty cycle from 0.5% to 50% a year long deployment can be simulated in under 4 days.

It should be appreciated that one or more aspects of a microbial fuel cell power system as described herein can be accomplished by one or more processors executing one or more sequences of one or more computer-readable instructions read into a memory of one or more computers from non-volatile or volatile computer-readable media capable of storing and/or transferring computer programs or computer-readable instructions for execution by one or more computers. Non-volatile computer readable media that can be used can include a compact disk, hard disk, floppy disk, tape, magneto-optical disk, PROM (EPROM, EEPROM, flash EPROM), SRAM, SDRAM, or any other magnetic medium; punch card, paper tape, or any other physical medium such as a chemical or biological medium. Volatile media can include a memory such as a dynamic memory in a computer.

Although particular embodiments, aspects, and features have been described and illustrated, it should be noted that the invention described herein is not limited to only those embodiments, aspects, and features. It should be readily appreciated that modifications may be made by persons skilled in the art, and the present application contemplates any and all modifications within the spirit and scope of the underlying invention described and claimed herein.

For example, envisioned applications of the present invention can include numerous marine sensors presently powered by batteries and thus limited in duration by battery depletion, which could provide scientific and/or operational and/or cost savings benefit if their duration could be greatly extended. Undersampling of the high frequency content of ocean signals is a widely recognized problem in oceanography and the present invention could provide a great benefit to a wide variety of ocean sensor uses by facilitating higher frequency sampling over set deployment durations. Benthic microbial fuel cells and control systems therefore in accordance with the present invention can be deployed in a wide range of environments such as the continental margins, fresh water lakes, rivers, estuaries, and harbors and can power a wide range of sensors and other instruments. It is envisioned that the invention disclosed here could also significantly impact next generation Department of Defense Distributed Netted Sensors Warfighting Capabilities and the Autonomous Operations Future Naval Capability as they pertain to in-water operations by increasing duration of battery-powered system components and reducing the frequency of cost and resources needed for intensive maintenance of battery-powered system components due to depletion of their batteries.

All such embodiments, configurations, and applications are also contemplated to be within the scope and spirit of the present disclosure.

What is claimed is:

1. A microbial fuel cell power system, comprising:
a microbial fuel cell configured to generate power from underwater voltage gradients;
at least two batteries connected to the microbial fuel cell, the batteries being configured to receive power from the microbial fuel cell, the batteries further being connected to a device configured to be powered by the batteries; and
a low-power controller comprising a microprocessor and a memory connected to the microbial fuel cell;
wherein the controller monitors a state of the batteries and periodically switches which of the at least two batteries will be in a charge state in which the battery is being charged by the microbial fuel cell and which will be in a discharge state in which the battery is providing power to the connected device such that the connected device is persistently powered by the microbial fuel cell.

2. The microbial fuel cell power system according to claim 1, wherein the microbial fuel cell comprises an electrically isolated fuel cell converter; and
further wherein the batteries are charged while in circuit with the connected device.

3. The microbial fuel cell power system according to claim 1, wherein the microbial fuel cell comprises a non-isolated fuel cell converter;
wherein a first one of the at least two batteries is in an offline state being charged by the microbial fuel cell while a second one of the at least two batteries is in an online state being discharged by the connected device; and
wherein the controller periodically switches the states of the first and second batteries.

4. The microbial fuel cell power system according to claim 1, wherein the batteries comprise 12V nickel metal hydride (NiMH) batteries.

5. The microbial fuel cell power system according to claim 1, wherein the batteries comprise 12V sealed lead acid (SLA) batteries.

6. The microbial fuel cell power system according to claim 1, wherein the controller is in a low-power mode until awoken by a signal, and further wherein the controller returns to the low-power mode after performing at least one scheduled task.

7. The microbial fuel cell power system according to claim 6, further comprising a real-time clock wherein the controller is awoken by a periodic signal from the real-time clock.

8. The microbial fuel cell power system according to claim 6, wherein the controller is awoken by a remote signal.

9. The microbial fuel cell power system according to claim 1, wherein the connected device comprises an Acoustic Doppler Current Profiler (ADCP).

10. The microbial fuel cell power system according to claim 1, wherein the connected device comprises a Shallow-Water Environmental Profiler in Trawl-Safe Real-Time Configuration (SEPTR).

11. The microbial fuel cell power system according to claim 1, further comprising a memory, wherein the controller is configured to record performance information regarding the power system to the memory, the performance information including at least one of system voltage, battery voltage, battery charge current, and battery discharge current.

12. The microbial fuel cell power system according to claim 11, wherein the controller is awoken once a day to switch the first and second of the at least two batteries between the charge and discharge states and is awoken once an hour to monitor the voltage and current of at least one of the microbial fuel cell and the battery being charged.

13. A control and monitoring system for a microbial fuel cell, comprising:
a low-power controller operatively connected to a microbial fuel cell configured to generate power from underwater voltage gradients, the microbial fuel cell being further operatively connected to at least two batteries configured to receive power from the microbial fuel cell, the batteries further being connected to a device configured to be powered by the batteries;
wherein the controller monitors a state of the batteries and periodically switches which of the at least two batteries will be in a charge state in which the battery is being charged by the microbial fuel cell and which will be in a discharge state in which the battery is providing power to the connected device such that the connected device is persistently powered by the microbial fuel cell.

14. The control and monitoring system according to claim 13, wherein the microbial fuel cell comprises an electrically isolated fuel cell converter; and
further wherein the batteries are charged while in circuit with the connected device.

15. The control and monitoring system according to claim 13, wherein the microbial fuel cell comprises a non-isolated fuel cell converter;
wherein a first one of the at least two batteries is in an offline state being charged by the microbial fuel cell while a second one of the at least two batteries is in an online state being discharged by the connected device; and
wherein the controller periodically switches the states of the first and second batteries.

16. The control and monitoring system according to claim 13, further comprising a real-time clock operatively connected to the controller, wherein the controller is activated by a signal from the real-time clock, the signal from the real-time clock further providing the controller date and time information comprising at least one of a current date and a current time, the controller using the date and time information to identify at least one scheduled task to be performed by the controller upon activation.

17. The control and monitoring system according to claim 13, wherein the controller is activated by a remote signal, the remote signal further including instructions regarding at least one action to be taken by the controller upon activation.

18. The control and monitoring system according to claim 13, wherein the controller remains in a low-power state until being activated, and further wherein the controller returns to the low-power state after performing all of its scheduled tasks.

19. The control and monitoring system according to claim 13, further comprising a memory, wherein the controller is configured to record performance information regarding the power system to the memory, the performance information including at least one of system voltage, battery voltage, battery charge current, and battery discharge current.

20. The microbial fuel cell power system according to claim 19, wherein the memory comprises a removable memory card.

21. The microbial fuel cell power system according to claim 19, wherein the controller further includes a transmitter, the recorded performance information being periodically transmitted by the transmitter to a receiver at a remote site.
